(19) United States
(12) Patent Application Publication
(10) Pub. No.: US 2005/0101183 A1
(43) Pub. Date: May 12, 2005

(54) Providing a bracket assembly to attach a device to a system chassis

(76) Inventors: Dean J. McCoy, Vista, CA (US); Bao Quoc Tran, Ramona, CA (US)

Correspondence Address: John D. Cowart;NCR Corporation, Law Department IP WHQ-4W, 1700 S. Patterson Blvd., Dayton, OH, 45479, US

(21) Appl. No.: 10/704,088

(22) Filed: Nov. 7, 2003

(51) Int. Cl. H01R 13/60

(52) U.S. Cl. 439/536

(57) ABSTRACT

A bracket for attaching an electronic device to a chassis of a system includes an opening to provide access to a structure (e.g., a connector) and first attachment element of the electronic device. The first attachment element is adapted to attach the structure to another component without attaching the bracket to the electronic device. The bracket has a second attachment element separate from the first attachment element to attach the bracket to the electronic device.

### BACKGROUND

A computer system includes a number of components, including a central processing unit (CPU), memory, and other electronic devices. Examples of electronic devices include storage media cards, video cards, modem cards, network cards, and other adapter cards. In high-performance computer systems, a large number of adapter cards can be installed in the system. In most cases, adapter cards are attached to adapter card brackets, which in turn are attached to the main chassis of the computer system.

Certain types of adapter cards have connectors to connect to cables. Such connectors have jackposts, one on either side of a connector, for receiving respective jackscrews to attach a cable connector to the connector of the adapter card. Traditionally, the jackposts and jackscrews are also used to attach the bracket to the adapter card. One reason for attaching the bracket using the jackpost attachment mechanism (including the jackposts and jackscrews) is to reduce radiated emissions. Attaching the bracket to the adapter card using the jackpost attachment mechanism provides a secure attachment between the bracket and the adapter card connector to provide a relatively good electromagnetic interference (EMI) shield.

However, an issue associated with attaching a bracket to an adapter card using jackposts and jackscrews is that each jackpost has to be tightened to a specific torque to prevent the jackposts from turning out when jackscrews are twisted out to remove a cable connector from the adapter card connector. If a user does not tighten a jackpost to the specific torque, then the jackpost may become loose during use. On the other hand, if the jackposts are tightened too much, damage to the adapter card connector may result.

### SUMMARY

In general, improved methods and apparatus are provided to attach a bracket to an electronic device (e.g., an adapter card). For example, an apparatus includes an electronic device having a structure and a first attachment element to attach the structure to another component. The apparatus further includes a bracket having an opening, the structure and first attachment element accessible through the opening, where the first attachment element is adapted to attach the structure to the another component without attaching the bracket to the electronic device. The bracket further has a second attachment element separate from the first attachment element, the second attachment element attaching the bracket to the electronic device.

Other or alternative features will become apparent from the following description, from the drawings, and from the claims.

### BRIEF DESCRIPTION OF THE DRAWINGS

FIG. 1 is a perspective view of an electronic device and a bracket for attachment to the electronic device.

FIG. 2 illustrates an electrically conductive clip to be provided between the bracket and the electronic device of FIG. 1.

FIG. 3 illustrates an assembled view of the electronic device and the bracket.

FIG. 4 is a front view of the bracket of FIG. 1.

FIG. 5 is a side view of a first side of the bracket of FIG. 4.

FIG. 6 is another side view of a second side of the bracket of FIG. 4.

FIG. 7 is a front view of another embodiment of the bracket of FIG. 1.

FIG. 8 is a front view of the clip of FIG. 2.

FIG. 9 is a side view of a first side of the clip of FIG. 7.

FIG. 10 is another side view of a second side of the clip of FIG. 7.

FIG. 11 illustrates a portion of a computer in which the electronic device of FIG. 1 is mounted using the bracket according to some embodiments of the invention.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

FIG. 1 illustrates an example electronic device 100, which has a circuit board 101 on which are mounted various components 102, including active components such as integrated circuit (IC) devices, and other components, such as resistors, capacitors, and so forth. The electronic device 100 shown in FIG. 1 is an adapter card for use in a system. In other embodiments, other types of electronic devices are employed.

The electronic device 100 has an edge connector 124 to enable the electronic device 100 to be plugged into a slot of a computer. In addition, the electronic device 100 includes additional connectors 104 and 106 for connection to other components, such as cables. In one example, the electronic device 100 is a network interface card (NIC) to enable communication between the computer in which the NIC is plugged into and cable(s) that are coupled to one or both of the connectors 104 and 106.

In other arrangements, an electronic device does not include the edge connector 124. Also, other examples of the electronic device include only one of the connectors 104 and 106, or more than two connectors.

The connector 104 is associated with attachment elements 108 and 110, one on each side of the connector 104. The attachment elements 108 and 110 are located in relative close proximity to the connector 104. The attachment elements 108 and 110 are used to attach the connector 104 to another component, such as a cable. In the illustrated example, the attachment elements 108 and 110 are jackposts for receiving respective jackscrews 174 and 176. In other embodiments, other types of attachment elements can be employed.

The connector 106 is similarly associated with attachment elements 112 and 114 on either side of the connector 106. The depicted attachment elements 112 and 114 are also jackposts for attaching the connector 106 to another component, such as a cable.

The connector 104 and jackposts 108, 110, protrude from a surface of a mounting plate 116. Similarly, the connector 106 and jackposts 112, 114 protrude from a surface of a mounting plate 117. In the illustrated arrangement, the mounting plates 116 and 117 are generally perpendicular to the main surface of the circuit board 101 on which the various components 102 of the electronic device 100 are mounted. In alternative embodiments, other relative arrangements of the mounting plates 116, 117 and the circuit board 101 can be provided. For example, the mounting plates 116, 117 can be parallel to the main surface of the circuit board 101.

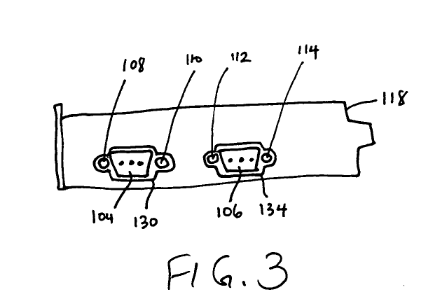

To attach the electronic device 100 to a chassis of a computer, a bracket 118 is attached to the electronic device 100. In accordance with some embodiments of the invention, attachment of the bracket 118 to the electronic device 100 is not accomplished by the jackposts 108, 110, 112, and 114. Instead, separate attachment elements 126 and 128 are used to attach the bracket 118 to the electronic device 100. An assembled view of the bracket 118 and the electronic device 100 is shown in FIG. 3.

A front view of the bracket 118 is provided in FIG. 4. The bracket 118 has two openings 130 and 134, each sized to enable a respective connector 104 or 106 and respective jackposts 108, 110, 112, or 114 to pass through. The opening 130 has an enlarged portion 136 and reduced portions 138 and 140 on either side of the enlarged portion 136. The enlarged portion 136 has a width W that is slightly larger than the width of the connector 104. Similarly, the reduced portions 138 and 140 each have a width that is slightly larger than the diameter of respective jackposts 108, 110.

The opening 134 also has an enlarged portion 142 and reduced portions 144 and 146 on either side of the enlarged portion 142. The sizes of the portions 142, 144, and 146 are selected to enable the connector 106 and jackposts 112 and 114, respectively, to protrude through the opening 134.

The integral portions 136, 138, and 140 make up the opening 130. Similarly, the integral portions 142, 144, and 146 make up the opening 134. In an alternative embodiment, as shown in FIG. 7, another bracket 118′ includes openings 180 and 182, with opening including discrete holes 184, 186, and 188, and opening 182 including discrete holes 190, 192, and 194. As used here, reference to an “opening” refers both to an opening having integral portions and to an opening having discrete holes.

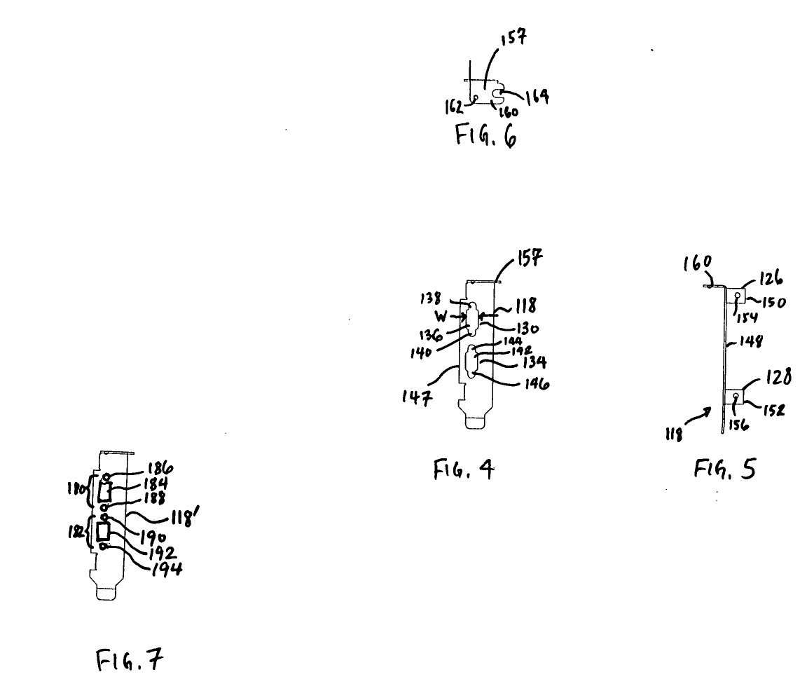

A side view of side 147 of the bracket 118 is shown in FIG. 5, which shows the attachment elements 126 and 128 protruding from a surface 148 of the bracket 118. Each attachment element 126 and 128 includes a respective tab 150 and 152. Each tab 150, 152, includes a respective opening 154, 156, through which a respective screw 170 or 172 (FIG. 1) or other attachment element can be extended to attach the bracket 118 to the circuit board 101 of the electronic device 100.

As shown in FIG. 1, the circuit board 101 includes first and second openings 158 and 159 that are aligned with openings 154 and 156 of the tabs 150 and 152 once the bracket 118 is mounted to the electronic device 100. Once aligned, the screws 170 and 172 are used to attach the bracket 118 and electronic device 100 together. In other embodiments, other attachment elements, such as a nut and bolt assembly, a snap-lock mechanism, rivets, and so forth, can be used to attach the bracket 118 to the electronic device 100.

FIG. 6 shows a side view of a side 157 of the bracket 118 (FIG. 4). On the side 157 of the bracket 118, a mounting member 160 is provided that has a cut 164 and an opening 162 to enable attachment of the mounting member 160 to a chassis of a computer by use of screws or other attachment elements. In the illustrated implementation, the mounting member 160 is bent with respect to the portion of the bracket 118 containing the openings 130 and 134.

By providing the openings 130 and 134 in the bracket 118, the connectors 104 and 106 can be attached to respective cables (or other components) with the jackposts (and respective jackscrews) without also attaching the bracket 118 to the electronic device 100 by the jackposts and jackscrews. This is accomplished by providing the opening 130 or 134 to have sufficient size to enable the jackposts to protrude through the opening. Instead of using the jackposts or jackscrews to attach the bracket 118 to the electronic device 100, the attachment elements 126, 128, 158, and 159 (which are separate from the jackposts and jackscrews) are used.

More generally, the openings 130 and 134 are provided to enable access to a structure of the electronic device 100 such that the structure can be attached to or connected to another component by a first attachment element without also attaching the bracket 118 to the electronic device 100. Instead, a second attachment element separate from the first attachment element is used to attach the bracket 118 to the electronic device 100.

The openings 130 and 134 in the bracket 118 enable removal of the bracket 118 from the electronic device 100 without having to loosen or detach the first attachment element (such as jackposts). As a result, the bracket 118 having a first profile can be easily replaced with a different bracket having a second, different profile without compromising the connection of the first attachment element to the electronic device 100. For example, jackposts have to be tightened to a specific torque to enable reliable performance. The tightening of the jackposts (or other first attachment element) can be performed at the factory so that the specific torque can be achieved. Different brackets can be easily mounted onto the electronic device 100 without affecting the tightening of the jackposts (or other first attachment element). The brackets are easily attachable to the electronic device 100 with the second attachment element.

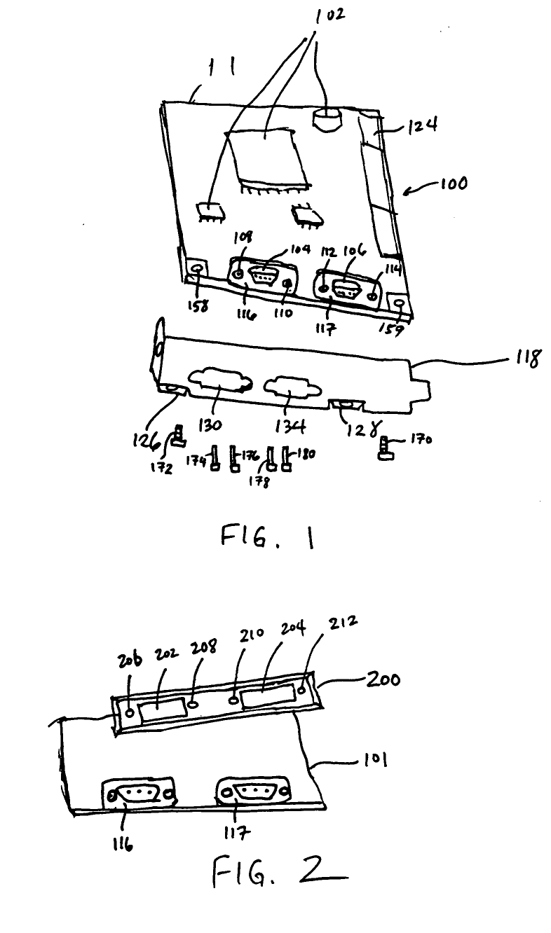

As shown in FIGS. 2 and 8, a clip 200 is provided to enhance electrical contact between the shell of each connector 104 and 106 and the bracket 118. The clip 200 provides a tight EMI (electromagnetic interference) shield between the connector shell and the bracket 118 to reduce radiated emissions through the openings 130 and 134 of the bracket 118. According to one embodiment, the clip 200 is a spring clip formed of an electrically conductive material, such as copper, another metal, or other electrically conductive non-metal materials.

The clip 200 has openings 202 and 204 through which connectors 104 and 106, respectively, of the electronic device 100 can protrude or extend. Also, the clip 200 has openings 206 and 208 on either side of the opening 202, and openings 210 and 212 on either side of the opening 204, to receive respective jackposts 108, 110, 112, and 114. The clip 200 is mounted onto the jackposts 108, 110, 112, 114, and connectors 104 and 106. After mounting of the clip 200, the bracket 118 is mounted to the electronic device 100.

The openings 202, 206, and 208, and openings 204, 210, and 212, are discrete openings. In alternative embodiments, the openings 202, 206, and 208 can be integrated together to form an integral opening, and the openings 204, 210, and 212 can be integrated together to form an integral opening, similar to the structure shown for the bracket 118 of FIG. 4.

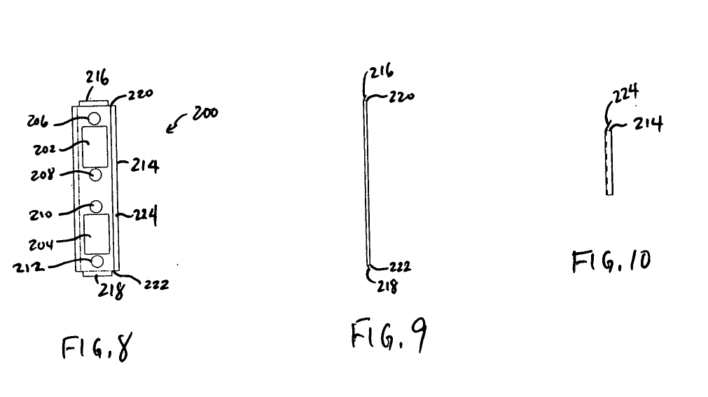

A side view of a side 214 of the clip 200 is shown in FIG. 9. Tabs 216 and 218 are provided at respective ends 220 and 222 of the clip 200. Each tab 216 and 218 is bent such that it is at a slanted angle with respect to the end 220 and end 222, respectively, of the main body of the clip 200.

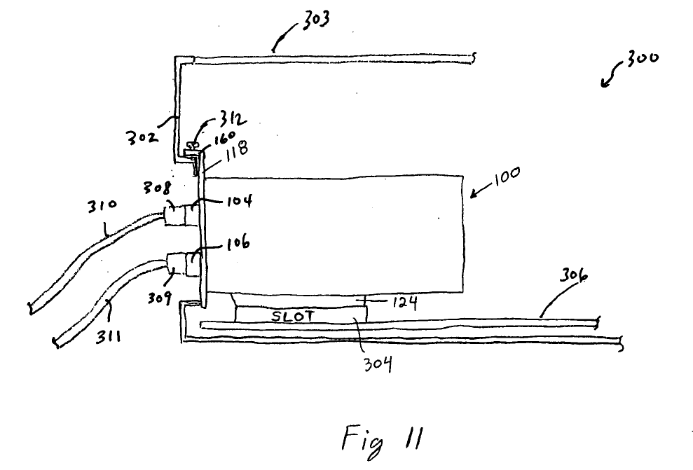

A side view of the end 220 is shown in FIG. 10. A tab 224 is provided on the side 214 of the clip 200. The tab 224 is also an angled tab that is at a slanted angle with respect to the side 214 of the clip 200. The angled tabs 216, 218, and 224, are deflectable to provide a spring-like engagement to surfaces of the mounting plates 116, 117, and/or bracket 118, which enhances contact between the connector shells and the bracket 118 to provide an effective EMI shield.

FIG. 11 illustrates the electronic device 100 mounted to a chassis 302 of a computer 300 (which has a chassis lid 303 attached to the chassis). The edge connector 124 of the electronic device 100 is plugged into a slot 304 of a main board 306 in the computer. A connector 308 at the end of a first cable 310 is plugged into the connector 104 of the electronic device 100. Similarly, a connector 309 at the end of a second cable 311 is plugged into the connector 106 of the electronic device 100. The bracket 118, which is attached to the electronic device 100, is mounted to the chassis 302 of the computer by connecting the mounting member 160 of the bracket 118 to the chassis 302 by a retaining screw 312 (or other type of attachment element).

While the invention has been disclosed with respect to a limited number of embodiments, those skilled in the art will appreciate numerous modifications and variations therefrom. It is intended that the appended claims cover such modifications and variations as fall within the true spirit and scope of the invention.

1. An apparatus comprising:
an electronic device having a structure and a first attachment element to attach the structure to another component; and
a bracket having an opening, the structure and first attachment element accessible through the opening, wherein the first attachment element is adapted to attach the structure to the another component without attaching the bracket to the electronic device,
the bracket further having a second attachment element separate from the first attachment element, the second attachment element attaching the bracket to the electronic device.

2. The apparatus of claim 1, wherein the bracket is adapted to attach the electronic device to a chassis of a system.

3. The apparatus of claim 1, wherein the bracket has a third attachment element adapted to attach the electronic device to a chassis of a system.

4. The apparatus of claim 3, wherein the bracket has a first portion containing the opening, and a second portion having the third attachment element.

5. The apparatus of claim 4, wherein the first and second portions of the bracket are bent with respect to each other.

6. The apparatus of claim 1, wherein the first attachment element comprises a jackpost.

7. The apparatus of claim 6, wherein the structure comprises a connector.

8. The apparatus of claim 7, wherein the connector comprises a first connector, the jackpost comprises a first jackpost, and the opening comprises a first opening, wherein the electronic device further has a second connector and a second jackpost, and the bracket further has a second opening, and wherein the second connector and second jackpost are accessible through the second opening,
the second jackpost adapted to attach the second connector to another component without attaching the bracket to the electronic device.

9. The apparatus of claim 8, wherein the electronic device further has third and fourth jackposts, the first and third jackposts located on either side of the first connector, and the second and fourth jackposts located on either side of the second connector.

10. The apparatus of claim 9, wherein the first and third jackposts are adapted to attach the first connector to a first cable, and the second and fourth jackposts are adapted to attach the second connector to a second cable.

11. The apparatus of claim 1, further comprising an electrically conductive piece electrically contacted to the structure and the bracket to reduce radiated emission.

12. The apparatus of claim 11, wherein the electrically conductive piece comprises spring members to enhance electrical contact to the bracket and structure.

13. The apparatus of claim 1, wherein the structure and first attachment element protrude through the opening.

14. The apparatus of claim 1, further comprising an electromagnetic interference (EMI) shield electrically contacted to the structure and the bracket.

15. The apparatus of claim 14, wherein the structure comprises a connector having a shell, the EMI shield electrically contacted to the shell and the bracket.

16. A system comprising:
a component;
a main board having a slot;
an electronic device mounted in the slot, the electronic device having a structure and a first attachment element proximate the structure; and
a bracket having an opening, the first attachment element and structure protruding through the opening, the first attachment element to attach the structure to the component without attaching the bracket to the electronic device,
wherein the bracket has a second attachment element separate from the first attachment element, the second attachment element attaching the bracket to the electronic device.

17. The system of claim 16, wherein the structure comprises a connector.

18. The system of claim 17, wherein the first attachment element comprises a jackpost.

19. The system of claim 18, wherein the component comprises a cable.

20. The system of claim 16, wherein the opening has plural integral portions, the structure accessible through a first one of the portions, and the first attachment element accessible through a second one of the portions.

21. The system of claim 16, wherein the opening comprises plural holes, the structure accessible through a first one of the holes, and the first attachment element accessible through a second one of the holes.

22. A method of mounting an electronic device in a system, comprising:
attaching the electronic device having a connector and one or more first attachment elements proximate the connector to another component, wherein attaching the electronic device to the another component is accomplished with the one or more first attachment elements;
attaching the electronic device to a chassis of a system with a bracket, wherein the bracket has an opening, the connector and the one or more first attachment elements accessible through the opening of the bracket,
wherein attaching the electronic device to the another component with the one or more first attachment elements is accomplished without attaching the bracket to the electronic device; and
attaching the bracket to the electronic device with one or more second attachment elements separate from the one or more first attachment elements.

23. The method of claim 22, wherein attaching the electronic device to the another component comprises attaching the electronic device to another component with one or more jackposts.

24. The method of claim 23, wherein attaching the electronic device to the another component comprises attaching the electronic device to a cable.

25. The method of claim 22, further comprising mounting a clip between the electronic device and the bracket, the clip to enhance electrical contact between a shell of the connector and the bracket to reduce radiated emission.

26. The method of claim 22, further comprising mounting an electromagnetic interference (EMI) shield that electrically contacts the connector and the bracket.

27. A bracket assembly for attaching an electronic device to a system chassis, the electronic device having a connector and a first attachment element, the bracket assembly comprising:
a bracket having an opening sized to enable the connector and the first attachment element to protrude through the opening, the opening to further enable the first attachment element to attach the connector to another component without attaching the bracket to the electronic device,
the bracket having a second attachment element separate from the first attachment element to attach the bracket to the electronic device.

28. The bracket assembly of claim 27, wherein the bracket has a first portion and a second portion, the first portion containing the opening, and the second portion containing a third attachment element to attach the bracket to the system chassis.

29. The bracket assembly of claim 27, wherein the opening has plural portions, the connector accessible through a first one of the portions, and the first attachment element accessible through a second one of the portions.

30. The bracket assembly of claim 27, wherein the opening has plural holes, the connector accessible through a first one of the holes, and the first attachment element accessible through a second one of the holes.
